(19) United States
(12) Patent Application Publication
(10) Pub. No.: US 2011/0018618 A1
(43) Pub. Date: Jan. 27, 2011

(54) CHARGE PUMP CIRCUIT

(75) Inventors: Shian-Sung Shiu, Taipei County (TW); Juan-Juan Liu, Wuxi (CN)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: GREEN SOLUTION TECHNOLOGY CO., LTD., Taipei County (TW)

(21) Appl. No.: 12/604,398

(22) Filed: Oct. 23, 2009

(30) Foreign Application Priority Data
Jul. 22, 2009 (TW) 98124640

(51) Int. Cl. G05F 1/10

(52) U.S. Cl. 327/536

(57) ABSTRACT

A rectifying device is used to prevent any reverse current in a charge pump circuit. Accordingly, energy stored in the charge pump circuit is prevented from being transmitted back to an input voltage source, or energy stored in a capacitor coupled to an output end is prevented from being transmitted back to the charge pump circuit and the input voltage source. Besides, a current limiting unit coupled to the input voltage source or/and the output end is used to protect devices of the charge pump circuit from being burned out due to an overly large current provided by the input voltage source to the charge pump circuit or/and an overly large current provided by the charge pump circuit to the output end when a short circuit occurs.

### CROSS-REFERENCE TO RELATED APPLICATION

This application claims the priority benefit of Taiwan application serial no. 098124640, filed on Jul. 22, 2009. The entirety of the above-mentioned patent application is hereby incorporated by reference herein and made a part of specification.

### BACKGROUND OF THE INVENTION

1. Field of the Invention

The invention generally relates to a charge pump circuit, and more particularly, to a charge pump circuit capable of preventing any reverse current and limiting current.

2. Description of Related Art

FIG. 1 is a schematic diagram of a conventional charge pump circuit. As shown in FIG. 1, the charge pump circuit includes a full bridge switch circuit, a first capacitor Cin, a second capacitor Cout, a voltage feedback circuit 30, and a control device 10. The full bridge switch circuit includes four transistor switches SW1-SW2 and SW3-SW4 respectively controlled by control signals Con_1 and Con_2 generated by the control device 10. The control device 10 generates the control signal Con_1 at a first timing and controls the transistor switches SW1 and SW2 to be turned on to form a first conduction path. Meanwhile, the first capacitor Cin stores the electric power of an input voltage VDD transmitted through the first conduction path. The control device 10 generates the control signal Con_2 at a second timing and controls the transistor switches SW3 and SW4 to be turned on to form a second conduction path. As a result, the first capacitor Cin transmits the electric power to a second capacitor Cout through the second conduction path, so that the second capacitor Cout generates an output voltage Vout. The first timing and the second timing are staggered and are not overlapped so as to avoid the second capacitor Cout undesirably releasing energy through the transistor switches SW3 and SW1.

The control device 10 includes an oscillator 12, a timing controller 14, and a hysteresis comparator 16. The hysteresis comparator 16 compares a voltage feedback signal VFB generated by the voltage feedback circuit 30 with a reference voltage V1 to generate a detection signal DET. The timing controller 14 receives the detection signal DET and a clock signal CLK generated by the oscillator 12. Besides, the timing controller 14 respectively generates the control signal Con_1 at the first timing and the control signal Con_2 at the second timing in a time-division manner according to a voltage level of the clock signal CLK.

In the conventional charge pump circuit, the transistor switches SW1 and SW3 are p-type metal oxide semiconductor (MOS) transistors. When the charge pump circuit has not been activated yet, the input voltage VDD transmits the electric power to the second capacitor Cout through body diodes of the transistor switches SW1 and SW3, so that the voltage drop across the second capacitor Cout is substantially equal to the input voltage VDD−2*VD, wherein VD is a forward bias voltage of the diode. When the charge pump circuit is activated, the output voltage Vout is larger than the input voltage VDD. Accordingly, in order to ensure that the transistor switches SW1 and SW3 are turned on or cut off, voltages (0,Vout) serve as switch levels of the control signals Con_1 and Con_2. As a result, the reverse current is also avoided. That is, it is avoided that the energy stored in the first capacitor Cin is transmitted back to the input voltage VDD through the transistor switch SW1, and that the energy stored in the second capacitor Cout is transmitted back to the first capacitor Cin and the input voltage VDD through the transistor switch SW3. When the control device 10 is in the normal operation, the voltage level of the output voltage Vout can be used to cut off the transistor switches SW1 and SW3. FIG. 2A illustrates a current Is flowing from the input voltage VDD to the ground through the transistor switches SW1 and SW3 when the conventional charge pump circuit is shorted. As shown in FIG. 2A, when an abnormal state (e.g., a shorted output end) occurs, the output voltage Vout is lowered to zero, and the transistor switches SW1 and SW3 are turned on all the time due to the switch levels of the control signals Con_1 and Con_2 being (0,Vout=0). Accordingly, the input voltage VDD continuously outputs a large current Is to the second capacitor Cout through the transistor switches SW1 and SW3, and the transistor switches SW1 and SW3 are burned out due to overheat.

Moreover, according to the related art, the voltages (0,VDD) and the voltages (0,Vout) may serve as the switch levels of the control signals Con_1 and Con_2 in another charge pump circuit. Please refer to FIG. 1 again. The timing controller 14 is coupled to the input voltage VDD and the output voltage Vout and determines which one of the input voltage VDD and the output voltage Vout is larger according to a comparison circuit. When the output voltage Vout is smaller than the input voltage VDD, the voltages (0,VDD) serves as the switch level of the control signals Con_1 and Con_2. By contrast, when the output voltage Vout is larger than the input voltage VDD, the voltages (0,Vout) serves as the switch level of the control signals Con_1 and Con_2. Accordingly, it is ensured that the transistor switches SW1 and SW3 are switched between an ON state and an OFF state. When the output end is shorted, and the output voltage Vout is suddenly lowered to zero, the switch level is changed from the voltages (0,Vout) to the voltages (0,VDD) after the comparison circuit determines that the input voltage VDD is larger than the output voltage Vout. However, there exists a delay time while the switch level is changed. Accordingly, when the switch level is changed, the transistor switches SW1 and SW3 are turned on at the same time, as shown in FIG. 2A. As a result, the current Is may burn out the transistor switches SW1 and SW3 due to overheat. Furthermore, FIG. 2B illustrates a current Is a flowing from the first capacitor Cin to the ground through the transistor switch SW3 when the conventional charge pump circuit is shorted. As shown in FIG. 2B, when the output end is shorted at the second timing, the transistor switches SW3 and SW4 are turned on, so that the voltage of the first capacitor Cin is raised to two times of the input voltage VDD. Meanwhile, the transistor switch SW3 endures two times of the input voltage VDD. Accordingly, the transistor switch SW3 may be burned out due to insufficient withstanding voltage thereof, and the current Is a are twice the current Is shown in FIG. 2A, so that the transistor switch SW3 may be burned out more possibly due to overheat.

### SUMMARY OF THE INVENTION

In light of foregoing, a rectifying device is used to prevent any reverse current in a charge pump circuit in an embodiment of the invention. Not only is the reverse current prevented in the charge pump circuit, but also the voltage levels (0, VDD) directly serve as the switch levels of a control signal. Therefore, the design of the circuit is simpler. In addition, a limiting unit is added between an input voltage source and an output end. Accordingly, transistor switches in the charge pump circuit are prevented from being burned out due to an overly large current passing through the transistor switches when the charge pump circuit is shorted.

One embodiment of the invention provides a charge pump circuit including a first capacitance unit, a second capacitance unit, a charging path, and a discharging path. The charging path couples an input voltage source to the first capacitance unit at a first timing so as to charge the first capacitance unit. The discharging path couples an output end to the first capacitance unit at a second timing so as to discharge the first capacitance unit. Here, the first timing and the second timing are staggered. The second capacitance unit stores energy released from the first capacitance unit. Here, the discharging path includes a current limiting unit, and the current limiting unit keeps a discharge current flowing from the first capacitance unit to the second capacitance unit within a predetermined output current limiting value.

One embodiment of the invention also provides another charge pump circuit including a first capacitance unit, a second capacitance unit, a charging path, and a discharging path. The charging path couples an input voltage source to the first capacitance unit at a first timing so as to charge the first capacitance unit. The discharging path couples an output end to the first capacitance unit at a second timing so as to discharge the first capacitance unit. Here, the first timing and the second timing are staggered. The second capacitance unit stores energy released from the first capacitance unit. Here, the discharging path includes a rectifying unit preventing the second capacitance unit from releasing energy to the first capacitance unit.

It is to be understood that both the foregoing general description and the following detailed description are exemplary and are intended to provide further explanation of the invention as claimed. In order to make the features and the advantages of the invention comprehensible, exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a conventional charge pump circuit.

FIG. 2A is a schematic diagram illustrating a current direction of the conventional charge pump circuit when the conventional charge pump circuit is shorted.

FIG. 2B is a schematic diagram illustrating a current direction of the conventional charge pump circuit when the conventional charge pump circuit is shorted initially.

FIG. 3 is a schematic diagram of a charge pump circuit according to a first embodiment consistent with the invention.

FIG. 4 is a schematic diagram of a charge pump circuit according to a second embodiment consistent with the invention.

FIG. 5 is a schematic diagram of a charge pump circuit according to a third embodiment consistent with the invention.

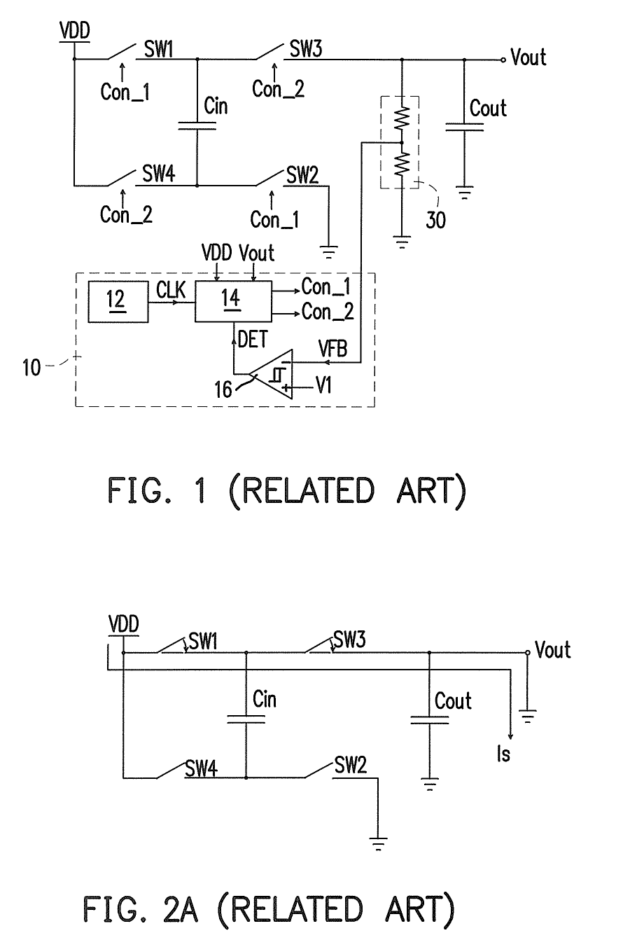

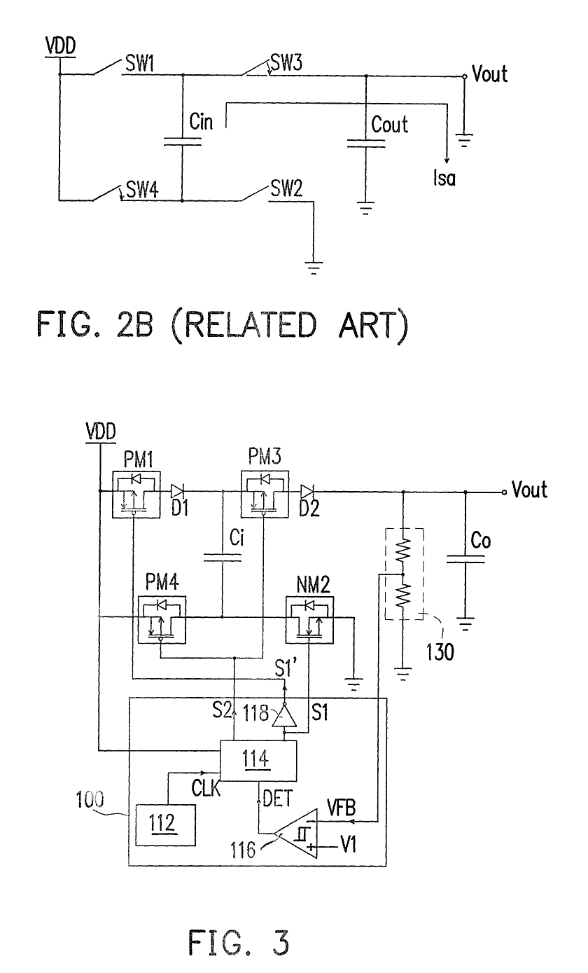

### DESCRIPTION OF EMBODIMENTS

FIG. 3 is a schematic diagram of a charge pump circuit according to a first embodiment consistent with the invention. As shown in FIG. 3, the charge pump circuit includes a control unit 100, a first capacitance unit Ci, a second capacitance unit Co, a charging path, and a discharging path. The charging path includes a first p-type metal oxide semiconductor (MOS) transistor PM1, a second n-type MOS transistor NM2, and an input rectifying device D1. The first p-type MOS transistor PM1 is coupled to an input voltage VDD and a first end of the first capacitance unit Ci. Moreover, a negative end of a parasitic diode of the first p-type MOS transistor PM1 is coupled to the input voltage VDD, and a positive end thereof is coupled to an output voltage Vout. The second n-type MOS transistor NM2 is coupled to a second end of the first capacitance unit Ci and the ground. Moreover, a negative end of a parasitic diode of the second n-type MOS transistor NM2 is coupled to the input voltage VDD, and a positive end thereof is coupled to the ground. The input rectifying device D1 can be a diode or any other element having a rectifying function. Besides, the input rectifying device D1 is coupled between the input voltage VDD and the first end of the first capacitance unit Ci to prevent the reverse current, so that the first capacitance unit Ci does not release the stored energy to the input voltage VDD. In the present embodiment, the input rectifying device D1 is a diode of which the positive end is coupled to the input voltage VDD and the negative end is coupled to the output voltage Vout. The discharging path includes a third p-type MOS transistor PM3, a fourth p-type MOS transistor PM4, and an output rectifying device D2. The third p-type MOS transistor PM3 is coupled to the output voltage Vout and the first end of the first capacitance unit Ci. Moreover, a negative end of a parasitic diode of the third p-type MOS transistor PM3 is coupled to the input voltage VDD, and a positive end thereof is coupled to the output voltage Vout. The fourth p-type MOS transistor PM4 is coupled to the input voltage VDD and the second end of the first capacitance unit Ci. Moreover, a negative end of a parasitic diode of the fourth p-type MOS transistor PM4 is coupled to the input voltage VDD, and a positive end thereof is coupled to the ground. The output rectifying device D2 can be a diode or any other element having the rectifying function. In addition, the output rectifying device D2 is coupled between the output voltage Vout and the first end of the first capacitance unit Ci to prevent the reverse current, so that the second capacitance unit Co does not release the stored energy to the first capacitance unit Ci and the input voltage VDD. In the present embodiment, the output rectifying device D2 is also a diode of which the positive end is coupled to the input voltage VDD and the negative end is coupled to the output voltage Vout. Furthermore, in case of the charge pump circuit being applied for a load having the lower power requirement, the equivalent input capacitor of the gate of a MOS transistor can serve as the second capacitance unit Co. That is, the gate of the MOS transistor is the first end of the equivalent input capacitor, and the drain, the source, and the substrate of the MOS transistor which are connected together are the second end of the equivalent input capacitor. Accordingly, the second capacitance unit Co can be built in the chip for educing the costs of the circuit.

The control unit 100 includes an oscillator 112, a timing controller 114, and a hysteresis comparator 116. The hysteresis comparator 116 compares a voltage feedback signal VFB generated by a voltage feedback circuit 130 with a reference voltage V1 to generate a detection signal DET. The timing controller 114 receives the detection signal DET and a clock signal CLK generated by the oscillator 112. Moreover, the timing controller 114 respectively generates control signals S1 and S1′ at a first timing and a control signal S2 at a second timing in a time-division manner according to a voltage level of the clock signal CLK. Here, the first timing and the second timing are staggered and are not overlapped. At the first timing, the control signal S1 is a signal at a high voltage level, and the control signal S1′ at a low voltage level is generated after the control signal S1 is inverted by an inverter 118. Thereby, the second n-type MOS transistor NM2 and the first p-type MOS transistor PM1 in the charging path are respectively turned on, so that the electric power of the input voltage VDD is transmitted to and stored in the first capacitance unit Ci so as to charge the first capacitance unit Ci. At the second timing, the control signal S2 is a signal at the low voltage level. Thereby, the third p-type MOS transistor PM3 and the fourth p-type MOS transistor PM4 in the discharging path are respectively turned on. The first capacitance unit Ci is discharged, and the energy stored therein is transmitted to the second capacitance unit Co.

It should be noted that the switch levels of the control signals S1, S1′, and S2 outputted by the control unit 100 refer to the voltage level (0, VDD) in the present embodiment. Under the normal operation, the first p-type MOS transistor PM1 and the third p-type MOS transistor PM3 are maintained to be turned on due to the output voltage Vout higher than the input voltage VDD, and thus the function of preventing the reverse current is provided by the input rectifying device D1 and the output rectifying device D2, respectively. When the output voltage Vout is lower than the input voltage VDD due to the abnormal operation of the circuit, it is ensured that the first p-type MOS transistor PM1 and the third p-type MOS transistor PM3 can be cut off. Moreover, the conductivity direction of the parasitic diodes of the first p-type MOS transistor PM1 and the third p-type MOS transistor PM3 is opposite to that of the input rectifying device D1 and the output rectifying device D2. Therefore, when the first p-type MOS transistor PM1 and the third p-type MOS transistor PM3 are cut off due to the abnormal operation of the circuit, the electric power of the input voltage VDD is unable to be transmitted to the output voltage Vout. Accordingly, the circuit is protected from being burned out. Furthermore, when an output end of the circuit is shorted initially, an overly large current outputted by the first capacitance unit Ci to the output end through the third p-type MOS transistor PM3 and the output rectifying device D2 can be prevented. As a result, the third p-type MOS transistor PM3 and the output rectifying device D2 are prevented from being burned out because of heat generated by the overly large current. Accordingly, the third p-type MOS transistor PM3 may be a p-type MOS transistor having a larger conductive resistance, and so the amount of the current outputted by the first capacitance unit Ci may be within a predetermined safe current value.

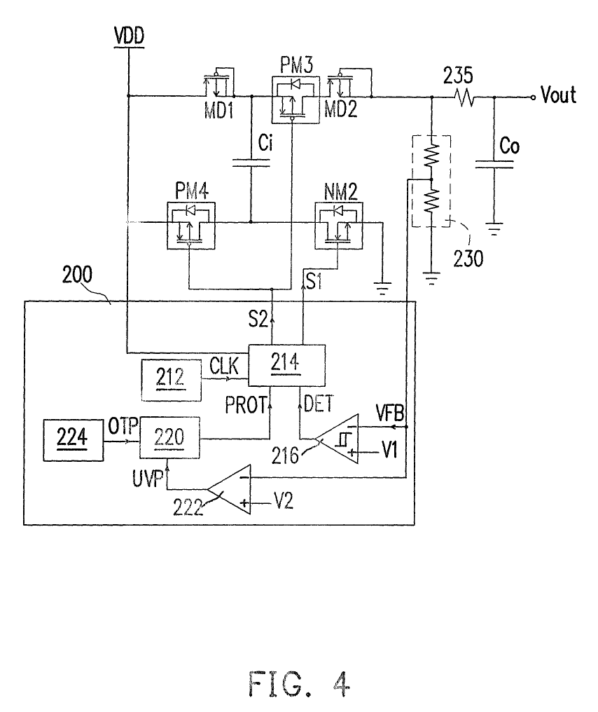

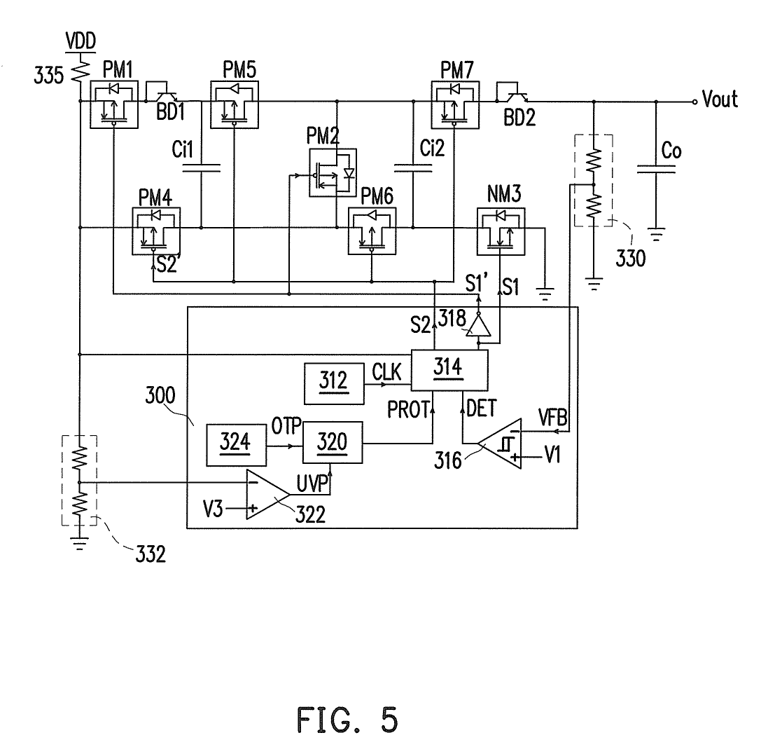

FIG. 4 is a schematic diagram of a charge pump circuit according to a second embodiment consistent with the invention. As shown in FIG. 4, the charge pump circuit includes a control unit 200, a first capacitance unit Ci, a second capacitance unit Co, a charging path, a discharging path, and an output current limiting device 235. Compared with the first p-type MOS transistor PM1 of the first embodiment shown in FIG. 3, the first p-type MOS transistor PM1 of this embodiment is omitted. Besides, the input rectifying device D1 of the first embodiment is replaced by a first MOS diode MD1 in the charging path of the present embodiment, and the output rectifying device D2 of the first embodiment is replaced by a second MOS diode MD2 in the discharging path of the present embodiment. In the present embodiment of the invention, the MOS diode is an MOS transistor of which the gate, the substrate, and the drain are connected together, so that the MOS transistor is equipped with characteristics of diode. Moreover, the output current limiting device 235 is added in the charge pump circuit to prevent the third p-type MOS transistor PM3 from being burned due to the overly large current flowing through the third p-type MOS transistor PM3. The output current limiting device 235 can be a resistor. Since the maximum voltage of the first capacitance unit Ci is twice the input voltage VDD when the charge pump circuit operates, proper impedance of the resistor can be determined according to the equation R=2*VDD/I1o, wherein I1o is a predetermined input current limiting value.

The control unit 200 includes an oscillator 212, a timing controller 214, a hysteresis comparator 216, a protector 220, an under voltage comparator 222, and an over temperature detector 224. The hysteresis comparator 216 compares a voltage feedback signal VFB generated by a voltage feedback circuit 230 with a reference voltage V1 to generate a detection signal DET. The timing controller 214 receives the detection signal DET and a clock signal CLK generated by the oscillator 212. Moreover, the timing controller 214 respectively generates control signals S1 at a first timing and a control signal S2 at a second timing according to a voltage level of the clock signal CLK in a time-division manner. Here, the first timing and the second timing are staggered and are not overlapped. The under voltage comparator 222 compares the voltage feedback signal VFB with an under voltage protection voltage V2 and generates an under voltage protection signal UVP when the output voltage Vout is lower than a predetermined under voltage value. The over temperature detector 224 detects temperature of the second n-type MOS transistor NM2, the third p-type MOS transistor PM3, and the fourth p-type MOS transistor PM4 to output an over temperature protection signal OTP when the temperature of any of the above-mentioned transistors is larger than a predetermined over temperature value.

The protector 220 is coupled to the under voltage comparator 222 and the over temperature detector 224 and outputs a protection signal PROT to the timing controller 214 when receiving the under voltage protection signal UVP or/and the over temperature protection signal OTP. Accordingly, the timing controller 214 cuts off the second n-type MOS transistor NM2, the third p-type MOS transistor PM3, and the fourth p-type MOS transistor PM4, so that the control unit 200 enters a protection mode.

In order to prevent the output voltage Vout from being lower than the predetermined under voltage value for a short period when the charge pump circuit operates initially or for other reasons, the protector 220 sets a predetermined delay time, and the protector 220 outputs the protection signal PROT only when continuing to receive the under voltage protection signal UVP for the predetermined delay time. Accordingly, the circuit may avoid erroneous judgment.

Under the present embodiment, although the first p-type MOS transistor PM1 is omitted, the function of the charge pump circuit is not affected. Under the normal operation, the first MOS diode MD1 can still work for preventing the reverse current. Under the abnormal operation, the third p-type MOS transistor PM3 is cut off, and the conductivity directions of the body diode of the third p-type MOS transistor PM3 and the second MOS diode MD2 are opposite, so that the electric power of the input voltage VDD is no longer transmitted to the output voltage Vout.

Moreover, in addition to the two configurations of the charge pump circuits in the above-described embodiments, the charge pump circuit of the invention with other different configurations can be applied as well. FIG. 5 is a schematic diagram of a charge pump circuit according to a third embodiment consistent with the invention. In the present embodiment, the charge pump circuit includes a control unit 300, a first capacitance unit, a second capacitance unit Co, a charging path, a discharging path, and an input current limiting device 335, wherein the first capacitance unit includes a first input capacitor Ci1 and a second input capacitor Ci2. The input current limiting device 335 is coupled between an input voltage VDD and the first capacitance unit to keep an input current from the input voltage VDD to the first capacitance unit Ci within a predetermined input current limiting value. The input current limiting device 335 can be a resistor of which the resistance can be set according to the equation R=2*VDD/Ii, wherein Ii is the predetermined input current limiting value.

The charging path includes a first p-type MOS transistor PM1, a second p-type MOS transistor PM2, a third n-type MOS transistor NM3, and a first bipolar junction transistor (BJT) diode BD1. In the present embodiment of the invention, the BJT diode refers to a BJT transistor of which a base and a collector are connected together, so that the BJT transistor is equipped with the characteristics of diode. The first p-type MOS transistor PM1 is coupled to the input voltage VDD and a first end of the first input capacitor unit Ci1. Moreover, a negative end of a parasitic diode of the first p-type MOS transistor PM1 is coupled to the input voltage VDD, and a positive end thereof is coupled to the output voltage Vout. The second p-type MOS transistor PM2 is coupled to a second end of the first input capacitor unit Ci1 and a first end of the second input capacitor unit Ci2. Moreover, a negative end of a parasitic diode of the second p-type MOS transistor PM2 is coupled to the input voltage VDD, and a positive end thereof is coupled to the output voltage Vout. The third n-type MOS transistor NM3 is coupled to a second end of the second input capacitor unit Ci2 and the ground. Moreover, a negative end of a parasitic diode of the third n-type MOS transistor NM3 is coupled to the input voltage VDD, and a positive end thereof is coupled to the ground. At the first timing, the first p-type MOS transistor PM1, the second p-type MOS transistor PM2, and the third n-type MOS transistor NM3 are turned on, while the first p-type MOS transistor PM1, the second p-type MOS transistor PM2, and the third n-type MOS transistor NM3 are turned off at other timing. Accordingly, at the first timing, the input voltage VDD charges the first input capacitor unit Ci1 and the second input capacitor unit Ci2 coupled in series, so that each of the first input capacitor unit Ci1 and the second input capacitor unit Ci2 stores a half of energy transmitted from the input voltage VDD. The first BJT diode BD1 is coupled between the input voltage VDD and the first end of the first input capacitor unit Ci1 to prevent the reverse current, so that the first capacitance unit Ci does not release the stored energy to the input voltage VDD.

The discharging path includes a fourth p-type MOS transistor PM4, a fifth p-type MOS transistor PM5, a sixth p-type MOS transistor PM6, a seventh p-type MOS transistor PM7, and a second BJT diode BD2. The fourth p-type MOS transistor PM4 is coupled to the input voltage VDD and the second end of the first input capacitor unit Ci1. Moreover, a negative end of a parasitic diode of the fourth p-type MOS transistor PM4 is coupled to the input voltage VDD, and a positive end thereof is coupled to the ground. The fifth p-type MOS transistor PM5 is coupled to the first end of the first input capacitor unit Ci1 and the first end of the second input capacitor unit Ci2. Moreover, a negative end of a parasitic diode of the fifth p-type MOS transistor PM5 is coupled to the input voltage VDD, and a positive end thereof is coupled to the output voltage Vout. The sixth p-type MOS transistor PM6 is coupled to the second end of the first input capacitor unit Ci1 and the second end of the second input capacitor unit Ci2. Moreover, a negative end of a parasitic diode of the sixth p-type MOS transistor PM6 is coupled to the input voltage VDD, and a positive end thereof is coupled to the ground. The seventh p-type MOS transistor PM7 is coupled to the first end of the second input capacitor unit Ci2 and one end of the second capacitance unit Co. Moreover, a negative end of a parasitic diode of the seventh p-type MOS transistor PM7 is coupled to the input voltage VDD, and a positive end thereof is coupled to the output voltage Vout. At the second timing, the fourth p-type MOS transistor PM4, the fifth p-type MOS transistor PM5, the sixth p-type MOS transistor PM6, and the seventh p-type MOS transistor PM7 are turned on, while the fourth p-type MOS transistor PM4, the fifth p-type MOS transistor PM5, the sixth p-type MOS transistor PM6, and the seventh p-type MOS transistor PM7 are cut off at other timing. Accordingly, at the second timing, the first input capacitor unit Ci1 and the second input capacitor unit Ci2 are coupled in parallel, and both of them are coupled to the input voltage VDD. As a result, the first input capacitor unit Ci1 and the second input capacitor unit Ci2 discharge by 1.5 times of the input voltage VDD, so that the released energy is stored in the second capacitance unit Co through the seventh p-type MOS transistor PM7 and the second BJT diode BD2. The second BJT diode BD2 is coupled between the second capacitance unit Co and the first capacitance unit to prevent the reverse current, so that the second capacitance unit Co does not release the stored energy to the first capacitance unit.

The control unit 300 includes an oscillator 312, a timing controller 314, a hysteresis comparator 316, an inverter 318, a protector 320, an under voltage comparator 322, and an over temperature detector 324. Compared with the under voltage comparator 222 of the second embodiment shown in FIG. 4, the under voltage comparator 322 in the present embodiment determines whether the input voltage VDD is lower than an under voltage or not by dividing the input voltage VDD through a voltage divider 332. When the input voltage VDD is lower than an under voltage, i.e., when a voltage-divided signal obtained by dividing the input voltage VDD through the voltage divider 332 is lower than an under voltage protection voltage V3, the under voltage comparator 322 generates an under voltage protection signal UVP, so that the control unit 300 enters the protection mode. Since other operations of the control unit 300 are similar to those of the control unit 200 shown in FIG. 4, no further description is provided herein.

To sum up, the rectifying device is used to prevent any reverse current in the charge pump circuit of the embodiments consistent with the invention. Accordingly, the energy stored in the charge pump circuit is prevented from being transmitted back to the input voltage source, or the energy stored in the capacitor coupled to an output end is prevented from being transmitted back to the charge pump circuit and the input voltage source. Accordingly, the reverse current in the charge pump circuit can be prevented, and the voltage level (0, VDD) can directly serve as the switch level of a control signal. As such, the design of the circuit is simple. Furthermore, in the embodiments consistent with the invention, the current limiting unit coupled to the input voltage source or/and the output end is used to protect devices of the charge pump circuit from being burned out due to an overly large current provided by the input voltage source to the charge pump circuit or/and an overly large current provided by the charge pump circuit to the output end when the charge pump circuit is shorted.

As the above description, the invention completely complies with the patentability requirements: novelty, non-obviousness, and utility. It will be apparent to those skilled in the art that various modifications and variations can be made to the structure of the invention without departing from the scope or spirit of the invention. In view of the foregoing descriptions, it is intended that the invention covers modifications and variations of this invention if they fall within the scope of the following claims and their equivalents.

What is claimed is:

1. A charge pump circuit, comprising:
a first capacitance unit;
a charging path coupling an input voltage source to the first capacitance unit at a first timing to charge the first capacitance unit;
a discharging path coupling an output end to the first capacitance unit at a second timing to discharge the first capacitance unit, wherein the first timing and the second timing are staggered; and
a second capacitance unit storing energy released from the first capacitance unit,
wherein the discharging path comprises a current limiting unit keeping a discharge current flowing from the first capacitance unit to the second capacitance unit within a predetermined output current limiting value.

2. The charge pump circuit as claimed in claim 1, wherein the current limiting unit is a p-type metal oxide semiconductor field effect transistor (PMOSFET) coupled to the first capacitance unit and the second capacitance unit, and the PMOSFET keeps the discharge current within the predetermined output current limiting value when the PMOSFET is turned on.

3. The charge pump circuit as claimed in claim 2, wherein the discharging path further comprises an output rectifying device preventing the second capacitance unit from releasing energy to the first capacitance unit.

4. The charge pump circuit as claimed in claim 1, wherein the current limiting unit comprises an output current limiting device keeping the discharge current within the predetermined output current limiting value.

5. The charge pump circuit as claimed in claim 4, wherein the discharging path further comprises an output rectifying device preventing the second capacitance unit from releasing energy to the first capacitance unit.

6. The charge pump circuit as claimed in claim 4, further comprising an input current limiting device keeping a current from the input voltage source within a predetermined input current limiting value.

7. The charge pump circuit as claimed in claim 3, wherein the output rectifying device is a diode, a metal oxide semiconductor diode (MOS diode), or a bipolar junction transistor diode (BJT diode).

8. The charge pump circuit as claimed in claim 1, wherein the charging path comprises an input rectifying device preventing the first capacitance unit from releasing energy to the input voltage source.

9. The charge pump circuit as claimed in claim 8, wherein the input rectifying device is a diode, a metal oxide semiconductor diode (MOS diode), or a bipolar junction transistor diode (BJT diode).

10. The charge pump circuit as claimed in claim 1, further comprising a control unit generating a plurality of control signals controlling the charging path to be turned on at the first timing and the discharging path to be turned on at the second timing, wherein voltage levels of the control signals are between a voltage level of the input voltage source and a common voltage level.

11. The charge pump circuit as claimed in claim 10, wherein the control unit comprises a protector generating a protection signal when the charge pump circuit is in an abnormal state, such that the control unit cuts off the charging path and the discharging path.

12. The charge pump circuit as claimed in claim 11, wherein the abnormal state of the charge pump circuit comprises an over-temperature state, an input over-voltage state, or an output under-voltage state.

13. A charge pump circuit, comprising:
a first capacitance unit;
a charging path coupling an input voltage source to the first capacitance unit at a first timing to charge the first capacitance unit;
a discharging path coupling an output end to the first capacitance unit at a second timing to discharge the first capacitance unit, wherein the first timing and the second timing are staggered; and
a second capacitance unit storing energy released from the first capacitance unit,
wherein the discharging path comprises a rectifying unit preventing the second capacitance unit from releasing energy to the first capacitance unit.

14. The charge pump circuit as claimed in claim 13, further comprising an output current limiting unit coupled to the first capacitance unit and the second capacitance unit to keep a discharge current flowing from the first capacitance unit to the second capacitance unit within a predetermined output current limiting value.

15. The charge pump circuit as claimed in claim 13, wherein the charging path comprises an input rectifying device preventing the first capacitance unit from releasing energy to the input voltage source.

16. The charge pump circuit as claimed in claim 15, further comprising a control unit generating a plurality of control signals to control the charging path turned on at the first timing and the discharging path turned on at the second timing, wherein voltage levels of the control signals are between a voltage level of the input voltage source and a common voltage level.

17. The charge pump circuit as claimed in claim 15, wherein the input rectifying device is a diode, a metal oxide semiconductor diode (MOS diode), or a bipolar junction transistor diode (BJT diode).

18. The charge pump circuit as claimed in claim 15, further comprising an input current limiting unit keeping a current from the input voltage source within a predetermined input current limiting value.

19. The charge pump circuit as claimed in claim 16, wherein the control unit comprises a protector generating a protection signal when the charge pump circuit is in an abnormal state, such that the control unit cuts off the charging path and the discharging path.

20. The charge pump circuit as claimed in claim 19, wherein the abnormal state of the charge pump circuit comprises an over-temperature state, an input over-voltage state, or an output under-voltage state.
